(19) United States
(12) Patent Application Publication
(10) Pub. No.: US 2023/0052049 A1
(43) Pub. Date: Feb. 16, 2023

(54) VIRTUAL CONTROLLER ARCHITECTURE AND SYSTEMS AND METHODS IMPLEMENTING SAME

(71) Applicant: Battelle Memorial Institute, Columbus, OH (US)

(72) Inventors: Giancarlo Canales Barreto, Dayton, OH (US); Nicholas L. Lamb, Upper Arlington, OH (US)

(21) Appl. No.: 17/818,427

(22) Filed: Aug. 9, 2022

Related U.S. Application Data
(60) Provisional application No. 63/232,143, filed on Aug. 11, 2021.
(60) Provisional application No. 63/234,859, filed on Aug. 19, 2021.

(51) Int. Cl. G06F 9/455

(52) U.S. Cl. CPC G06F 9/45558; G06F 2009/45579; G06F 2009/4557

(57) ABSTRACT

In an approach to virtualizing communication channels between one or more hardware components and a controller, a system includes: a first controller implemented in a reconfigurable hardware device; and a virtual platform stratus having a plurality of input/output (I/O) ports for electrically coupling with the one or more hardware components and receiving one or more electrical signals therefrom, and where the VPS is configured to generate one or more data frames from the one or more electrical signals; and where the virtual platform stratus is configured to send the data frames to the first controller and/or provide electrical signaling to the one or the one or more hardware components based on data frames received from the first controller.

### CROSS-REFERENCE TO RELATED APPLICATIONS

The present application claims the benefit of the filing date of U.S. Provisional Application Ser. No. 63/232,143, filed Aug. 11, 2021, and U.S. Provisional Application Ser. No. 63/234,859, filed Aug. 19, 2021, the entire teachings of which applications are hereby incorporated herein by reference.

### TECHNICAL FIELD

The following disclosure relates generally to dynamic interfacing of physical hardware devices with virtualized controller environments through reprogrammable hardware.

### BACKGROUND

Currently, hardware devices such as the brakes on a car or a button on a smartphone transmits and/or receive signals that are received by a dedicated handler. This dedicated handler could be a microprocessor or other embedded system, or a singular device that functions mechanically (versus electromechanically).

However, this creates a single point of failure as loss of a dedicated handler also means loss of an associated hardware component. Within the context of critical hardware subsystems, such as the engine subsystem within a vehicle, the loss of a single dedicated handler can render the entire vehicle inoperable.

There exists a need to increase the fault tolerances within such hardware subsystems while still allowing for the use of commercial off-the-shelf (COTS) hardware components.

### BRIEF DESCRIPTION OF THE DRAWINGS

Reference should be made to the following detailed description which should be read in conjunction with the following figures, wherein like numerals represent like parts.

FIG. 1 shows an example virtual platform stratus (VPS) architecture consistent with aspects of the present disclosure.

FIG. 2 shows an example vehicle system implementing the VPS architecture of FIG. 1, in accordance with aspects of the present disclosure.

FIG. 3 shows an example VPS layer suitable for use as the VPS within the vehicle system of FIG. 2.

FIG. 4 shows an example vehicle implementing a VPS consistent with aspects of the present disclosure.

FIG. 5 shows an example telemetry controller suitable for use in the VPS architecture of FIG. 1.

FIG. 6 shows an example agnostic message format consistent for use by the telemetry controller of FIG. 5.

FIG. 7 shows an example virtual network interface (VNI) suitable for use in the VPS architecture of FIG. 1.

### DETAILED DESCRIPTION

In general, the present disclosure is directed to a virtual platform stratus (VPS) that can provide one or more virtualized channels of communication between hardware endpoints or components and the devices responsible for receiving data and/or controlling operation of the hardware endpoints.

In addition, the present disclosure is also generally directed to a secure logic fabric, and the input/output (I/O) signals and signal controls associated with interfacing with hardware endpoints.

In contrast, existing hardware endpoint solutions dedicate 1-1 mappings of devices such as a forward collision sensor to one or more general purpose input/output (GPIO) pins on a microcontroller. Those pins on the microcontroller can only be used for handling the specific signals from that singular device, and no other microcontrollers receive a copy of the signals from the forward collision sensor unless the first microcontroller processes the data and then outputs a new signal to another device.

Using a VPS consistent with the present disclosure provides an abstraction from the actual transmission and reception of the various signals or impulses that hardware endpoints generate (or otherwise produce), and the processing agent/controller associated with the hardware endpoints. This in turn advantageously increases system/platform redundancy, improves verification and validation of functionality, simplifies hardware designs, and enables reuse of components that would be traditionally mapped 1:1 with associated hardware endpoints. Moreover, systems implemented with a VPS consistent with the present disclosure can significantly reduce their size, weight, power, and cost (SWaP-C) relative to existing solutions by, for example, eliminating or otherwise reducing the necessity of complex wiring harnesses.

A VPS consistent with the present disclosure also further allows for wiring reuse (e.g., overlapping signals, etc.) between unassociated devices as the communication channels/paths can be utilized by N number of hardware endpoints and associated controllers.

A VPS consistent with the present disclosure further provides a mechanism for converting raw analog/digital signals to/from upstream controllers that are unaware of the particular interface requirements of a particular hardware endpoint. A VPS consistent with the present disclosure further allows for multiple inputs/multiple outputs (MIMO) to and from discrete endpoint hardware devices from one or more upstream controllers.

Note, while examples and scenarios of the present disclosure refer specifically to automotive platforms, this disclosure is not limited in this regard. For example, various aspects and features of the present disclosure are applicable to numerous other environments such as space platforms (e.g., satellites), datacenter environments (e.g., those used for cloud computing), and mobile platforms such as laptops and smartphones.

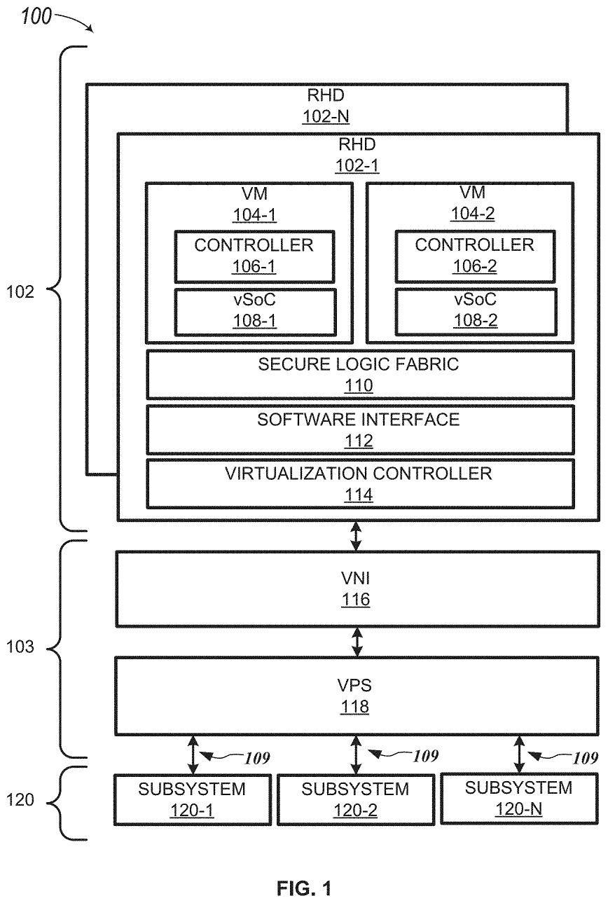

FIG. 1 is a block diagram illustrating an example embodiment of a virtual platform stratus (VPS) architecture 100 consistent with aspects of the present disclosure. Like numerals refer to like elements unless otherwise provided.

The VPS architecture 100 can be implemented in a wide range of systems including, but not limited to, vehicle systems, industrial control systems, or any other system that features discrete hardware devices that would traditionally require a dedicated controller, such as a microprocessor, for interfacing and utilizing the discrete hardware devices during operation.

As shown, the VPS architecture 100 includes a plurality of reconfigurable hardware devices (RHDs) 102, a hardware interconnect layer 103, and a hardware subsystem layer 120.

The plurality of RHDs 102 may be implemented as field programmable gate arrays (FPGAs), complex programmable logic devices (CPLDs), or any other device capable of providing reprogrammable hardware. It should also be noted that various aspects and features of the present disclosure can be implemented in other devices/hardware that are not necessarily reprogrammable such as application-specific integrated circuits (ASICs). For example, a VPS architecture consistent with the present disclosure may alternatively use non-programmable hardware rather than RHDs, or a combination of both RHDs and non-programmable hardware. Thus, the particular example of FIG. 1 is not intended to be limiting and one or more of the RHD instances shown at 102 may be implemented as such non-programmable hardware and/or can be implemented with different functionality than what is shown in FIG. 1.

For example, some RHD instances may have no need for a software interface 112 because the functionality and I/0s are terminated directly with virtual machines (VMs) within the RHD. Another example highlighting possible alternate RHD designs is where a VM 104-1 leverages a plurality of identical virtual System-On-Chips (SoCs), or vSoCs. A vSoC incorporates reconfigurable hardware to implement and virtualize all or a portion of the resources available in existing SoCs. The vSoC may be an SoC instance within reconfigurable hardware to accelerate virtualized system components and securely isolate virtualized system components [i.e., eliminate shared hardware resources]. The vSoC instances can provide a meta-virtualization approach to virtualized resource allocation and management. A configuration including identical vSoC 108-1 and vSoC 108-2 with no controller 106-2 allows the implementation of technologies such as digital twins. To achieve this, vSoC 108-1 may be a soft processor implementing a particular microcontroller or IC. The second vSoC 108-2 may implement a software emulator that executes on the same input as vSoC 108-1. In this design there are now two different and distinct implementations (e.g., one hardware and one software) that can compute the same result. This allows the platform to determine if one (or both) vSoC instances is operating erroneously. These examples illustrate some possible alternate RHD designs but are not meant to be limiting in nature and additional configurations are expected as the technologies can be modified for different operating environments.

The VPS architecture 100 may include a plurality of RHDs shown collectively at 102 and individually as RHD 102-1 through RHD 102-N, where N can represent any number of RHDs. Note, a VPS architecture consistent with the present disclosure can also utilize a single RHD. Further note, that although the various components of the VPS architecture 100 are shown as discrete elements, this disclosure is not necessarily limited in this regard. For instance, the components of the hardware interconnect layer 103 may be implemented at least in part in an RHD, such as the RHD 102-1.

As shown, the RHD 102-1 implements a plurality of VMs, namely a first VM 104-1 and a second VM 104-2. The first and second VMs 104-1 and 104-2 are isolated from each other such that memory of the first VM 104-1 is inaccessible to the second VM 104-2, and vice-versa. A communications channel (e.g., TCP/IP) and/or other suitable interface (e.g., serial) may be used to convey information/data between these VMs.

For example, the first VM 104-1 implements a first vSoC instance 108-1 and the second VM 104-2 implements a second vSoC instance 108-2. The first and second vSoC instances 108-1 and 108-2 can implement the same or different processor hardware architectures, often referred to as soft processors within the context of RHDs. For example, the first vSoC instance 108-1 can implement a Reduced-instruction-set Computing (RISC) processor, e.g., an ARM® processor, and the second vSoC instance 108-2 can implement an x86-based processor, for example the AO486 Verilog core. The particular processor architectures provided above are provided as examples and not for purposes of limitation.

The first and second VMs 104-1 and 104-2 further implement first and second controllers 106-1 and 106-2, respectively. The first and second controllers 106-1 and 106-2 are instantiated via respective first and second vSoCs 108-1 and 108-2. The first and second controllers 106-1 and 106-2 are further implemented as a controller for processing data from hardware of the plurality of hardware subsystems 120-1, 120-2, through 120-N. For example, and as discussed further below, the first and second controllers 106-1 and 106-2 can be implemented as controllers within a vehicle such as an engine controller and shifter controller. The first and second controllers 106-1 and 106-2 are therefore configured to operate identically to their non-programmable/dedicated hardware equivalents.

The secure logic fabric 110 securely distributes the logical implementation of one or more VMs (e.g., 104-1 and 104-2) in a manner that allows a virtualization controller 114 to direct communications I/O from a VM to an appropriate subsystem(s), and vice-versa. The secure logic fabric can be implemented in an FPGA or other suitable hardware platform. The secure logic fabric 110 may be responsible for the secure deployment of vSoCs to ensure that signals and/or other possible side effects, such as intentionally introduced cyberattacks, are impractical between VM instances such as 104-1 and 104-2. The secure logic fabric 110 can improve platform resiliency to failures and faults through adaptively reprogramming a RHD 102. The secure logic fabric 110 can also improve resistance to side-channel leakages through usage of specialized logic blocks that leverage technologies such as, but not limited to, dual-rail logic. This protects RHD-based features such as VMs 104-1 and 104-2.

The secure logic fabric 110 thus provides resistance against side-channel leakages, resiliency to failures and faults. This is done at least in part by lifting an original design so that it uses specially crafted blocks such as dual-rail logic. The secure logic fabric 110 can also protect against exploitation of these faults or leakages from within the VM, VM-to-VM, and/or from an external device.

The secure logic fabric 110 may be implemented as an extension to technologies such as existing FPGA fabrics whereby logic slices can be grouped together and operated on individually. In one example, these grouped logic slices can be programmed and de-programmed independently of the other logic slices. In another example, these grouped logic slices can be designed as co-dependent or otherwise joined together to form a larger sub-system or system.

The software interface 112 may be configured to allow for software, e.g., code executed in user space, to access one or more components within the RHDs. Thus, a processor external to the RHD 102-1, for example, could execute user code that interfaces with the RHD 102-1 via the software interface 112. This design allows for existing or otherwise legacy platforms to leverage the RHD 102-1 or equivalent to gain access to subsystem(s) 120-1, etc.

One aim of the present disclosure includes implementing legacy standards such as hardware interrupts to support interfacing and communicating with RHDs. One example approach is to allow software platforms running on external processor(s) to leverage acceleration options through use of signals to an RHD. In this approach, an application programmer interface (API) can be established that allows secure, accelerated access to RHD-base resources, with this access being mediated through the software interface 112. In another example approach, the external platform can have direct I/O pins or interface(s) to an RHD and the secure logic fabric 110 and/or other components (e.g., within RHDs 102 and/or hardware interconnect layer 103) can intercept and route the signals to the appropriate endpoint in the platform. In this example, the communications or data transfer can optionally be processed and mediated by the software interface 112. Other methods to support legacy and/or existing external hardware and software are within the scope of this disclosure and the examples provided above are not intended to be limiting.

The virtualization controller 114 is an abstraction layer configured to expose the presence of RHDs to other components of the platform. For instance, there can be numerous RHDs deployed in a given implementation, and each RHD is at least partially isolated physically from the others. To clarify this notion, partial isolation is applicable when multiple VMs exist within a single RHD. This is in contrast to designs where each RHD contains a single VM. In the latter, more complete or “full” isolation can be achieved between execution environments because the underlying hardware is physically separated. To simplify communications between RHDs and between RHDs and external hardware or software, virtualization controllers 114 are instantiated and can provide a common means of securely communicating/interfacing with RHDs.

The hardware interconnect layer 103 comprises a VNI 116 and a VPS 118. The VNI 116 is configured to communicate with each RHD of the plurality of RHDs 102. More particularly, the VNI 116 may be configured to instantiate at least a portion of a signal plane through which data frames may be passed to/from the plurality of RHDs 102, as discussed in greater detail below. Moreover, the VNI 116 can implement point-to-point encryption. Point-to-point encryption advantageously eliminates or otherwise reduces the potential for cyberattacks and other attacks that can, for example, introduce erroneous messages or signals within the communications interface of a platform. So long as the private keys used for the point-to-point encryption remain secured, e.g., via a trusted platform module, middleman and other attacks such as spoofing, message injection, and so on can, can be virtually eliminated and immediately identified by the platform. Upon receipt of suspect messages, the virtualization controller 114 (and/or software interface 112 and/or other elements of the RHD 102-1) can detect the anomaly and optionally take corrective actions. Some example non-limiting corrective actions include alerting other components in VPS architecture 100 that an adverse condition was detected, isolating the suspected compromised subsystem 120-N, and/or re-instantiating a VM instance such as 104-1.

The VPS 118 comprises a plurality of general-purpose input/output (GPIO) pins, which may also be grouped together to create one or more I/O ports, and circuitry for interfacing with the GPIO pins, as discussed in greater detail below. The circuitry of the VPS 118 is further configured to receive electrical signals 109 from a plurality of hardware subsystems shown collectively at 120 and individually as subsystems 120-1, 120-2, through 120-N, where N can represent any number of subsystems. The VPS 118 may be configured to generate data frames based on the received electrical signals 109 and/or provide electrical signaling to the hardware subsystems based on data frames received from the plurality of RHDs 102. Thus, the VPS 118 may be configured to communicate bidirectionally with each of the hardware subsystems in a manner that utilizes “native” electrical signaling, e.g., in a manner that allows for COTS hardware components to be utilized with the VPS 118.

Each hardware subsystem of the plurality of hardware subsystems 120-1 through 120-N includes at least one hardware device/component, such as a sensor. In the context of a vehicle, for example, hardware sensors can include temperature sensors, collision sensors, fuel level sensors, emission sensors, door sensors, proximity sensors (e.g., lidar), occupancy sensors, tire pressure sensors, and driver awareness sensors. In addition to sensors, and within the example context of a vehicle, other hardware subsystem can include, for example, axels, transmissions, engines, brakes, windshield wipers, thermostats, turn signals, alarms, and so-on. Note, a single hardware subsystem may also be utilized.

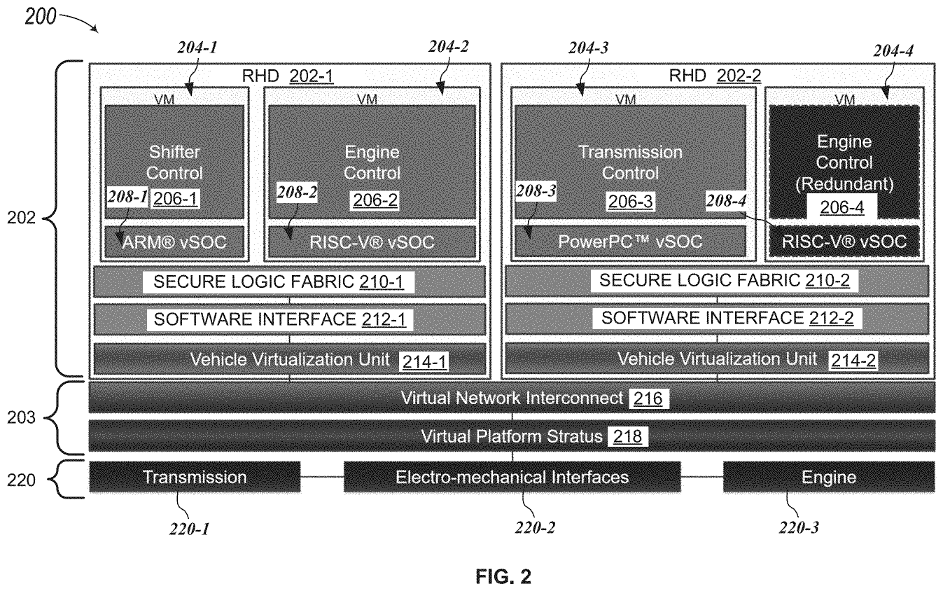

FIG. 2 shows an example of the VPS architecture 100 of FIG. 1 implemented within a vehicle system 200. As shown, the vehicle system 200 includes a plurality of RHDs 202, a hardware interconnect layer 203, and a plurality of hardware subsystems 220.

In the example of FIG. 2, the plurality of RHDs 202 are implemented as first and second RHD 202-1 and RHD 202-2, as discussed above. The first RHD 202-1 comprises a first virtual machine 204-1 which implements a first vSoC 208-1. The first virtual machine 204-1 instantiates a shifter controller 206-1. The first virtual machine 204-1 implements the shifter controller 206-1 in a manner which is identical to a dedicated hardware shifter control which is implemented in a non-programmable hardware device, e.g., an ARM® chip.

The first RHD 202-1 further comprises a second virtual machine 204-2 which implements a second vSoC 208-2. The second virtual machine 204-2 instantiates an engine controller 206-2. The second virtual machine 204-2 implements the engine controller 206-2 in a manner which is identical to a dedicated hardware engine controller which is implemented in a non-programmable hardware device, e.g., RISC-V® chip.

The first RHD 202-1 further comprises a first secure logic fabric 210-1, a first software interface 212-1, and a first vehicle virtualization unit 214-1.

The second RHD 202-2 comprises a third virtual machine 204-3 which implements a third vSoC 208-3. The third virtual machine 204-3 instantiates a transmission controller 206-3. The third virtual machine 204-3 implements the transmission controller 206-3 in a manner which is identical to a dedicated hardware transmission control which is implemented in a non-programmable hardware device, e.g., a PowerPC™ architecture.

The second RHD 202-2 further comprises a fourth virtual machine 204-4 which implements a fourth vSoC 208-4. The fourth virtual machine 204-4 instantiates a redundant engine controller 206-4. The fourth virtual machine 204-4 implements the redundant engine controller 206-4 as the same type of controller as the engine controller 206-2 for redundancy. Thus, in the event of a fault with the engine controller 206-2, data frames and/or signals from the engine subsystem 220-3 may then be provided to the redundant engine controller 206-4.

The second RHD 202-2 further comprises a second secure logic fabric 210-2, a second software interface 212-2, and a second vehicle virtualization unit 214-2.

The hardware interconnect layer 203 of the vehicle system 200 includes a virtual network interconnect (VNI) 216 and a virtual platform stratus (VPS) 218.

The plurality of hardware subsystems 220 include a transmission subsystem 220-1, an electro-mechanical subsystem 220-2, and an engine subsystem 220-3. Each of the plurality of hardware subsystems each include at least one hardware device for operation of a vehicle.

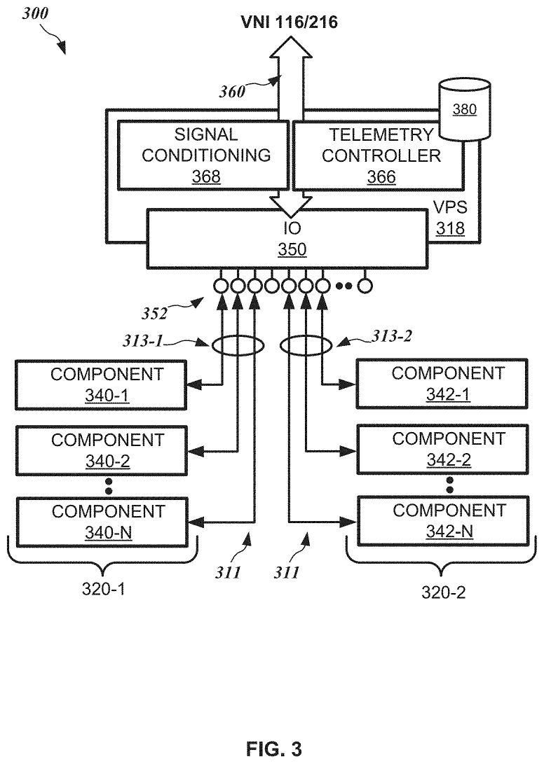

FIG. 3 shows an example 300 of a VPS 318 consistent with aspects of the present disclosure. The VPS 318 can be utilized within the vehicle system 200 of FIG. 2, for example. It should be noted that although the example of FIG. 3 illustrates a vehicle system, the VPS 318 can be implemented in a wide range of systems including, but not limited to, vehicle systems, industrial control systems, or any other system that features discrete hardware devices that would traditionally require a dedicated controller.

The VPS 318 is configured to electrically couple to at least one hardware subsystem and is configured to electrically couple to a plurality of hardware subsystems such as first hardware subsystem 320-1 and second hardware subsystem 320-2. As discussed above, each hardware subsystem can include one or more hardware components. For example, and as shown in FIG. 3, the first hardware subsystem 320-1 includes hardware components 340-1 to 340-N and the second hardware subsystem 320-2 includes hardware components 342-1 to 342-N. The hardware components of each of the first and second hardware subsystems 320-1, 320-2 are configured to send and/or receive electrical signals 109 (see FIG. 1) via electrical conductors 311. The electrical signals 109 may be analog, digital, or a combination of analog and digital signals.

As shown, the VPS 318 includes an input-output (TO) interface 350 to electrically couple to the hardware components of the first hardware subsystem 320-1 and the second hardware subsystem 320-2.

The I/O interface 350 includes a plurality of GPIO pins 352, which may also be grouped together to create one or more I/O ports. Each of the plurality of GPIO pins 352 is configured to electrically couple to a respective hardware component of the first hardware subsystem 320-1 and the second hardware subsystem 320-2 via electrical conductors 311. Note, the plurality of GPIO pins 352 are illustrated in a simplified manner and each component of the first hardware subsystem 320-1 and the second hardware subsystem 320-2 can couple to one or more of the plurality of GPIO pins 352. For instance, some hardware components can include a single pin for input or output of electrical signals from a respective controller device while others can include a plurality of pins for communication (e.g., bidirectional send and receive) with an associated controller. Accordingly, the particular example shown in FIG. 3 of electrical interconnection between hardware components and corresponding GPIO pins of the plurality of GPIO pins 352 is not intended to be limiting.

The electrical conductors 311 may also be optionally coupled to the GPIO pins 352 by way of one or more wiring harnesses. For example, and as shown in FIG. 3, the first hardware subsystem 320-1 can include a first optional wire harness 313-1 that simplifies coupling of electrical conductors 311 from the hardware components 340-1 through 340-N to the plurality of GPIO pins 352. Likewise, the second hardware subsystem 320-2 can include a second optional wire harness 313-2 to simplify coupling of electrical conductors 311 from the hardware components 342-1 to 342-N to the plurality of GPIO pins 352.

The I/O 350 is configured to receive electrical signals from one or more hardware components of the first and/or second hardware subsystems via the plurality of GPIO pins 352.

The VPS 318 further comprises a telemetry controller and signal conditioning circuitry 368. The telemetry controller 366 is implemented within an RHD.

The telemetry controller 366 is configured to utilize a telemetry database 380 which can be local, e.g., within a memory of the telemetry controller, and/or be remotely accessible, e.g., via a network.

The telemetry database 380 can include, for example, one or more data tables in the form of flat files, SQL tables, or any other datastores. The telemetry database 380 includes a mapping table that associates each GPIO pin of the plurality of GPIO pins 352 with a corresponding hardware component.

The telemetry database 380 can further include a table that associates each of the hardware components with a component type. For example, the hardware component 340-1 may be implemented as a temperature sensor-type device that outputs temperature measurements via a proportional analog output voltage. The telemetry database 380 may therefore be utilized to both map GPIO pins of the plurality of GPIO pins with specific hardware components, and also to identify the particular characteristics of the output signal from the hardware components.

Note, the telemetry database 380 can include predetermined definitions that provide, for instance, the particular electrical characteristics for output signals such as signal type (e.g., analog, digital), signal envelopes (e.g., high/low ranges), and signal rate (e.g., signals per second). The telemetry controller 366 may utilize these definitions to convert electrical signals to/from the hardware components as discussed below. The telemetry controller 366 may also utilize the definitions for purposes of detecting the particular type of hardware component that is coupled to one or more GPIO pins without necessarily having a priori knowledge of the hardware component type and/or the electrical characteristics of the output from the hardware component. The telemetry controller 366 may utilize a model that utilizes the aforementioned definitions as an input to enable automatic detection of hardware component types and/or electrical output characteristics of hardware components coupled to the I/O 350 via machine learning, heuristics, and/or any other suitable artificial intelligence approach.

The VPS 318 further comprises signal conditioning circuitry 368. The signal conditioning circuitry 368 can include, for example, AC to DC converters, DC step up/down converters, lowpass (LC) filters, rectifiers, and so on. The signal conditioning circuitry 368 may be implemented within one or more RHDs to allow for dynamic reconfiguration.

In operation, the telemetry controller 366 is configured to capture the electrical signals 109 (See FIG. 1) from hardware components via the I/O 350. The telemetry controller 366 is further configured to optionally filter or otherwise condition captured signals via the signal conditioning circuitry 368. The telemetry controller 366 is further configured to digitize the electrical signals 109 in a predetermined format, for example, to generate data frames. The data frames may comport with a standard packet protocol such as the Transmission Control Protocol (TCP), although this disclosure is not limited to any particular standard or protocol. For example, the data frames may be simply in-memory data structures. In any event, the data frames include a payload with the digitized electrical signal from a given hardware component, and also further include header information that includes, for instance, an identifier of the particular hardware component the payload (i.e., the digitized signal) was captured from, an identifier of the component type associated with the hardware device, an identifier of the type of signal within the payload (e.g., analog, digital), and/or any other metadata that can be utilized to process the digitized signal within the payload by downstream components (e.g., within the RHD 102-1 of FIG. 1).

The telemetry controller 366 then transmits the data frames via the signal plane 360, which is provided at least in part by the VNI 116/216 (See FIGS. 1 and 2). The telemetry controller 366 transmits the data frames in a stream that maintains temporal order of the captured electrical signals from the hardware components and allows for real-time processing of the captured electrical signals by the downstream components. Thus, virtual communication channels between controllers and corresponding hardware devices can be provided via the data frames.

The VNI 116/216 may then act as a router and ensure that data frames are sent to one or more target RHDs that are configured to process the data frames. The VNI 116/216 may utilize a database (not shown) that maps specific hardware component types with the RHDs suitable for processing output data from those specific hardware components. Notably, this can include two or more RHDs receiving data frames from a single hardware component to achieve redundancy and so called “hot swapping” of controllers in the event the primary controller for a given hardware component encounters a fault or otherwise becomes inoperable.

The RHDs receiving the data frames may then utilize the virtualization controller 114 (See FIG. 1) to provide the data to the appropriate controllers in a form which is suitable for processing. For example, and in the context of the vehicle system 200 shown in FIG. 2, data frames directed to the shifter controller 206-1 may then be converted to a form which is in a “native” format that the shifter controller 206-1 is configured to process. In this way, the shifter controller 206-1 can utilize the identical circuitry and/or microcode as its non-programmable equivalent to process the payload data from the data frames without modification. Stated differently, the shifter controller 206-1 is able to receive and process signals from one or more associated hardware components as if the same were wired in a dedicated manner to the shifter controller 206-1. This advantageously allows for re-use of existing controller technologies without requiring a fixed or otherwise dedicated, i.e., 1:1, connection, between controller inputs and associated hardware components. Likewise, such existing controllers may be dynamically instantiated within RHDs for purposes of providing fault tolerance and self-healing (e.g., via hot swapping).

The telemetry controller 366 may be configured to receive data frames via the signal plane 360 which originate from the downstream controllers of the RHDs. For example, the shifter controller 206-1 may be configured to generate data frames based on the output signals from the shifter controller 206-1. For example, the output signals may include a digital signal that is configured to cause a hardware component within the transmission subsystem 220-1 to change engine gears, reduce throttle, or otherwise adjust engine operation. The vehicle virtualization unit 214-1 may then generate data frames and send the same to the telemetry controller 366 via the signal plane 360. The telemetry controller 366 may then cause the same to be output in an appropriate electrical format, e.g., using one or more components of the signal conditioning circuitry 368, via one or more GPIO pins of the plurality of GPIO pins.

For example, the telemetry controller 366 may identify a target GPIO pin based on an identifier within the received data frames and/or through querying the telemetry database 380. The telemetry controller 366 may then cause an appropriate electrical signal to be output via the target GPIO pin such that a hardware component electrically coupled to the same receives an electrical signal that comports with the constraints of the hardware component. For example, the component 340-1 may be a hardware component that governs operation of an engine. In this example, the component 340-1 may be configured to receive a DC voltage signal and adjust operation of the engine based on the received DC voltage signal exceeding a predetermined threshold. The telemetry controller 366 therefore ensures that the electrical signal output via the electrical conductors 311 comports with constraints/requirements of the target hardware component.

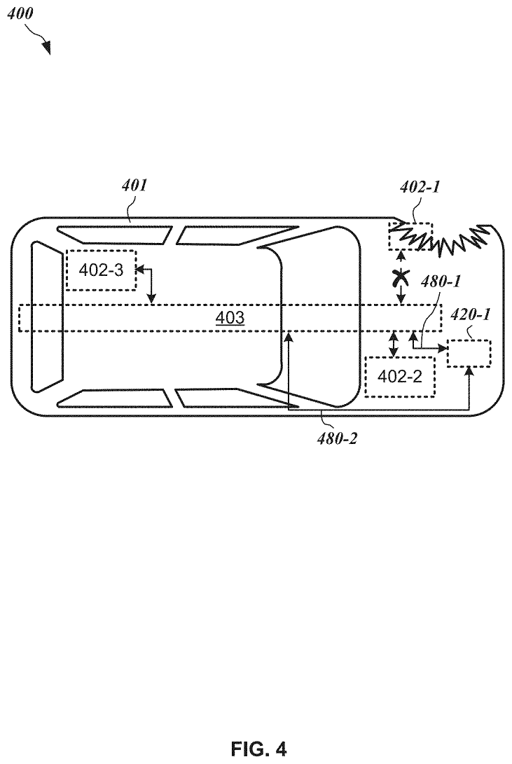

FIG. 4 shows an example vehicle system 400 implementing a VPS consistent with aspects of the present disclosure. As shown, the example vehicle system 400 includes a vehicle 401. The vehicle 401 can comprise, for example, a passenger vehicle, a commercial vehicle, or a vehicle intended for military use such as a Humvee or tank.

The vehicle 401 includes a plurality of controllers, namely the first controller 402-1, the second controller 402-2, and the third controller 402-3, which are implemented via RHDs. The vehicle 401 further includes at least one hardware component such as the first hardware component 420-1. The first hardware component 420-1 can be implemented as a front-end collision sensor, for example.

Each of the first controller 402-1, the second controller 402-2, and the third controller 402-3 are electrically coupled to a hardware interconnect layer 403 consistent with aspects of the present disclosure. Likewise, the first hardware component 420-1 is electrically coupled to the hardware interconnect layer 403. The hardware interconnect layer 403 includes a VPS (not shown), such as the VPS 300 as shown in FIG. 3.

As further shown, the first hardware component 420-1 includes a primary electrical conductor 480-1 and a secondary electrical conductor 480-2 to electrically couple to the hardware interconnect layer 403. Thus, if one of the primary or secondary electrical conductors becomes damaged or otherwise compromised, the other of the primary or secondary electrical conductor can be utilized to maintain electrical communication with the hardware interconnect layer 403.

Likewise, in circumstances where one or more of the controllers, such as the first controller 402-1 shown in FIG. 4, becomes damaged or otherwise inoperable, the VPS of the hardware interconnect layer 403 may then route data frames from the first hardware component 420-1 to a redundant controller, such as the second controller 402-2 or the third controller 402-3. Note, the controllers may not necessarily be pre-instantiated and instead may be provisioned and brought into service during operation of the vehicle 401. For example, the second controller 402-2 and/or third controller 402-3 may be dynamically instantiated within available programmable fabric of an RHD based on the first controller 402-1 becoming damaged or otherwise inoperable.

From the foregoing it will be appreciated that, although specific examples have been described herein for purposes of illustration, various modifications may be made without deviating from the spirit and scope of the disclosure described herein. Accordingly, the disclosure is not limited except as by corresponding claims and the elements recited by those claims. In addition, while certain aspects of the disclosure may be presented in certain claim forms at certain times, the inventors contemplate the various aspects of the disclosure in any available claim form. For example, while only some aspects of the disclosure may be recited as being embodied in a computer-readable medium at particular times, other aspects may likewise be so embodied.

Additional use cases are now described to further elucidate alternate embodiments that leverage VPSs and other technologies consistent with the present disclosure. In one such example, a constellation of space assets is employed. In this use case, the VPS 318 along with the signal conditioning circuitry 368 and/or telemetry controller 366 enables the ability for one space asset (e.g., a satellite) to collect data and convert it to a redistributable payload. This payload can be passed to VNI 116/216, for example, which reads a redistribution tag (or another indicator) that indicates the payload is destined for an off-platform endpoint. The off-platform endpoint, in this example, can be another satellite, an alternate space vehicle, an alternate space system, an aircraft, a terrestrial ground station, or any other appropriate endpoint. One salient aspect in this use case is the observation that a physical system that is remote from the system that collected the signals from the components 320-1 is leveraged to receive, process, and optionally respond to the redistributable payload. As indicated, this model supports bidirectional communication whereby the off-platform endpoint can prepare one or more response redistributable payloads that are delivered to either the original space asset or another asset altogether. Thus, such platforms leveraging aspects of the present disclosure can link together to form a variety of networked configurations.

Consider another example within a datacenter environment. In this example, signals from components 320-1 across a plurality of computing (or similar) servers can be collected and routed through their respective I/O 350 and through their VNI 116/216 to a consolidated processing platform. This example allows maintainers of datacenter, or similar environments, to reduce the overhead associated with distributing an entire VPS architecture 100 with each platform or unit within a server rack. More specifically, numerous subsystems (e.g., subsystem 120-1) can dispatch their signals through I/O 350 and VNI 116/216 where the redistributable payloads may then be sent to one or more designated endpoints for processing. This configuration supports technologies such as malware scanning and detection, hardware anomaly detection, system failure analysis, and other specific or bulk processing capabilities.

Consider another example within the context of a war zone or active combat area. In such a scenario, strategic, tactical, and operational data can be collected from a plurality of sensors, systems, and subsystems (e.g., subsystem 120-1, subsystem 120-2, and subsystem 120-N) and sent to a plurality of adjacent and remote nodes via the VPS 118 and VNI 116 components in manners discussed above. This configuration advantageously enables continuous regional and global tracking and feedback for military decision making. In addition, this configuration can leverage encrypted communications through VNI 116 to reduce or eliminate the potential for false battle-time data to be introduced into the environment from hostile third parties, for example.

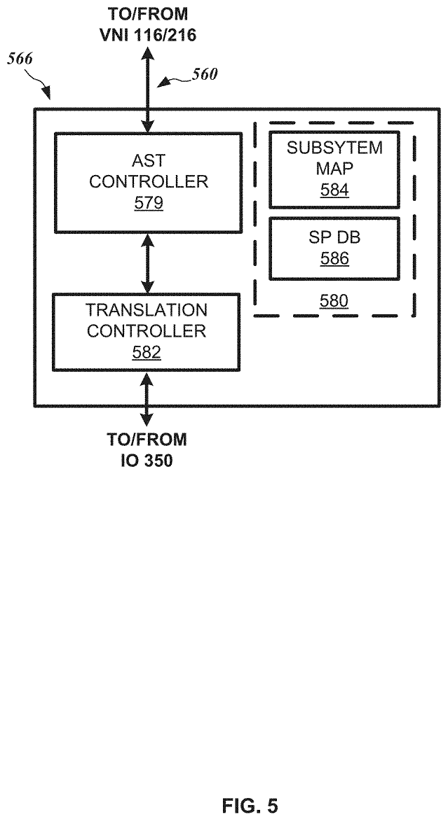

FIG. 5 shows an example of a telemetry controller 566 consistent with aspects of the present disclosure. The telemetry control 566 may be implemented as the telemetry controller 366 within the VPS architecture as shown in the examples of FIGS. 1 and 3. Thus, the various features and examples described above with regard to the telemetry controller 366 are equally applicable to the telemetry controller 566.

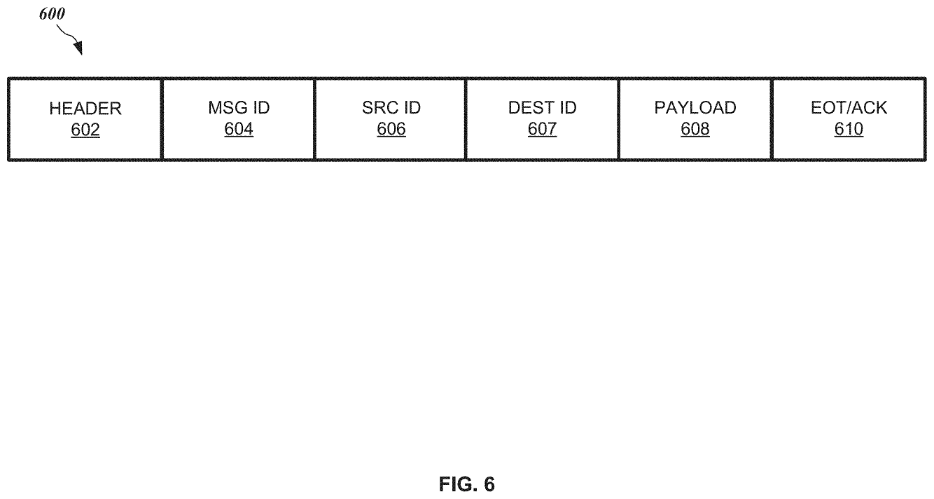

However, it should be noted that the telemetry controller 566 may not necessarily be implemented within a VPS consistent with the present disclosure and can be utilized in virtually any scenario where agnostic signal processing is desired to allow for the capture and routing of signals that are not necessarily natively capable of transmission via a common pipe or network. For instance, the telemetry controller 566 can be configured to translate analog signals, digital signals, or a mixture of both, into an agnostic message format that includes a header and a payload that encapsulates a representation of such digital and/or analog signals within a data payload. One such example agnostic message format is discussed further below with reference to FIG. 6. This agnostic message format may be a data structure that can be communicated via a standard network protocol such as TCP/IP.

As shown, the telemetry controller 566 includes a plurality of components that can be implemented via hardware, software, or any combination thereof. The components of the telemetry controller 566 may be implemented, at least partially, in an RHD device such as an FPGA. In more detail, the plurality of components of the telemetry controller 566 may include an agnostic signal tunneling (AST) controller 579, a translation controller 582 and a telemetry database 580.

The AST controller 579 may be configured to communicatively couple to a VNI consistent with the present disclosure via a signal plane 560. The AST controller 579 may be configured to communicate bi-directionally with the VNI. Note, the AST controller 579 may be configured to communicate with a plurality of VNIs, e.g., for purposes of redundancy, load sharing, and/or network segmentation.

The translation controller 582 may be configured to convert signals received from a component, e.g., by way of I/O 350 (See FIG. 3) and convert the same into the agnostic message format. As discussed in further detail below, the translation controller 582 can utilize the telemetry database 580 to determine, for instance, the particular parameters to utilize in an associated header and the packing parameters for payload data. the translation controller 582 is able to communicate bidirectionally with the AST controller 579 to send and receive messages that comport with the agnostic message format.

The telemetry database 580 includes a plurality of databases and/or datastores. The plurality of databases can include a subsystem map 584, and a subsystem protocol (SP) database (DB) 586.

The subsystem map 584 includes a plurality of entries, whereby each entry associates an identifier of a subsystem component/endpoint with the identifier of one or more VNI targets that are associated with the subsystem component. For example, the identifier of the subsystem component can be a unique ID that corresponds to an I/O port, or pin number(s) of the I/O 350 (see FIG. 3). Thus, subsystem components such as the engine controller of an engine control subsystem can be logically identified by the ID of the I/O port(s) to which it is communicatively coupled. The VNI target(s) can correspond to one or more VNIs. As discussed in greater detail below, the VNIs can be responsible for the processing of messages received via the signal plane 560 such that the payloads of the messages are processed using the logic of “native” controllers. For example, one or more RHDs may be configured to implement the logic of an existing engine controller. Such RDHs may then be referred to as a virtual engine controller. In this example, a VNI can be configured to provide the data payloads to such virtual engine controllers as an input in a manner that is identical to how the physical, i.e., non-virtual, equivalent of the engine controller receives data as an input from a subsystem component. The VNI may then utilize output(s) of such virtual engine controllers to pass signals back to a target subsystem component via the signal plane 560. These signals are also sent via the signal plane 560 using the agnostic message format to the AST controller 579 for return processing. Accordingly, the AST controller 579 can use the subsystem map 584 to determine the particular destination for messages in both directions, e.g., to ensure messages reach one or more target VNIs for processing and/or to ensure messages reach a target subsystem component by way of the translation controller 582.

The SP DB 586 includes one or more protocol definitions for generation of messages that comport with the agnostic message format. For instance, the protocol definitions may include a protocol format type, e.g., TCP or UDP. The protocol definitions may also define one or more message characteristics such as a max payload size for messages, encryption parameters, timestamps, quality of service parameters, and/or access controls.

In operation, the telemetry controller 566 can receive analog and/or digital signaling from subsystem components that comports with various different communication protocols. The telemetry controller 566 is configured to convert these various signals from a raw form into a digitized version of the same. This digitized raw data may then be inserted as a payload into one or more messages that comport with the agnostic message format discussed above. Note, the header and/or payload of such messages may also include additional characteristics such as timing, filtering, sampling, quantization, reconstruction, and other signal processing parameters. Additional parameters associated with the electrical characteristics of the signal may also be included, and this disclosure is not limited to only those examples provided above.

FIG. 6 shows one example of an agnostic message format 600 consistent with aspects of the present disclosure. As shown, the agnostic message format 600 includes a header 602, a message (MSG) ID 604, a source (SRC) ID 606, a destination (DEST) ID 607, a payload 608, and an end-of-transmission (EOT)/acknowledgement (ACK) 610.

The header 602 can include a value such as the one used in the Gigabit Ethernet header: 0x55555555555555D5. In one example, the value can be used to provide, for example, a signal to/from a VNI that a message transmission is occurring via the signal plane 560 (See FIG. 5). The MSG ID 604 can be a value that simply increments (e.g., 1, 2, 3) and/or can be a value that identifies a particular telemetry controller associated with the message. In some cases, a VNI may use this value to ensure a message reaches a target telemetry controller for processing. In the context of messages sent from a telemetry controller to a VNI, the SRC ID 606 is a unique identifier that corresponds to the subsystem component associated with the message. For example, the SRC ID 606 may be an I/O pin identifier for a subsystem component as discussed above and/or an identifier of the telemetry controller. The SRC ID 606 is a tuple that includes an identifier of the I/O pin and the identifier of the telemetry controller. The DEST ID 607 is this example is a unique identifier of a target VNI for processing the message. In the context of a message sent from a VNI to a telemetry controller, the SRC ID 606 may then identify the particular VNI and the DEST ID 607 may then identify the particular target telemetry controller and/or I/O pin.

The payload 608 comprises a digital representation of data captured from a subsystem component, e.g., via I/O 350 (See FIG. 3). In one example, the digital representation can include a digital waveform representation.

The EOT/ACK 610 can be used as a flag to indicate an end of transmission. Alternatively, or in addition, the EOT/ACK 610 may be utilized as a flag to indicate successful processing of a message by a VNI, for example.

Thus, in one example, a telemetry controller consistent with the present disclosure can perform analog-to-digital conversions in a manner that accounts for the component communication standards (e.g., Ethernet, (Peripheral Component Interconnect Express (PCIe), Universal Serial Bus (USB), pulse width modulation (PWM), Quadrature Amplitude Modulation (QAM), Phase-Shift Keying (PSK), Chirp Spread Spectrum (CSS), On-Off Keying (OOK), and so on), and can communicate this data to a relevant controller for processing. Thus, aspects of the present disclosure can be integrated into a range of embodiments to enable component communication that avoids the necessity of 1:1 connectivity between components and controllers.

Each communication channel therefore includes one end that couples to a component in a conventional manner and a telemetry controller consistent with the present disclosure on the other end. The telemetry controller can then convert signals from the component into messages that comport with the agnostic message format for routing, e.g., to a VNI, and for conversion from the agnostic message format to a ‘native’ signal for output to a component. Thus, a wide range of complex and/or simple protocols can be tunneled without the telemetry controller having an understanding or a priori knowledge of the underlying signal format and content. In addition, the communication to/from a component occurs in a transparent manner whereby the component communicates with a VNI or a virtual controller without an awareness that such communication is occurring in a non-native manner.

Note, a telemetry controller consistent with the present disclosure is not necessarily limited to capturing of signals over copper or otherwise “wired” connections. The telemetry controller may also be configured to capture wireless signals such as signals that comport with the IEEE 802.11 format, which is commonly referred to as a Wi-Fi. Such wireless signals can include transport protocols such as TCP/IP. A telemetry controller consistent with the present disclosure is capable of capturing such data, converting the same to the agnostic message format, and then back again in a loss-less manner (e.g., returned to an original format without loss of data). Accordingly, a telemetry controller consistent with the present disclosure can convert a raw input signal and the protocol carried thereby into a standard format, and then convert the standard format back to a (native) signal that comports with the raw input signal for output. In addition, the telemetry controller's signal processing may also reduce noise from the original signal or in some cases introduce additional noise to the output signal. In the case of noise being added to the signal, it is preferable that the changes to the output signal are within predetermined tolerances of the original/nominal signaling protocol.

Thus, the present disclosure enables agnostic, transparent data conversion to allow for the propagation of data in a manner that was necessarily achievable via the raw signal format alone. The source of that data does not necessarily need to be modified to operate in this manner as the telemetry controller can dynamically adjust capture to comport with the source format. The end result is tunneling of data between a component and one or more target controllers with an encapsulation scheme that preserves the raw signal in a loss-less manner.

A telemetry controller consistent with the present disclosure thus avoids the necessity of having a plurality of discrete, dedicated signal processers to process data from components as each data telemetry controller can process signals from N number of controllers.

In a complex platform like a modern vehicle, an airplane, or a satellite, there are potentially hundreds or thousands of components that “speak” in dozens of “languages.” These languages are protocols, and their method of speaking are signals. A telemetry controller consistent with the present disclosure simplifies a platform's design by abstracting the complexity of handling all these components' different communications requirements. Therefore, any signal (and therefore any protocol riding on top of the signal) is processed and tunneled thereby reducing the issues associated with communications within the platform.

Technologies that leverage one or more complex subsystems such as vehicles, airplanes, and space systems (satellites, spacecraft, space stations), often utilize a plurality of different communication interfaces. Each communication interface can introduce both a unique message structure as well as physical interconnection requirements such as specialized connectors, physical wiring, and supporting devices such as switches, routers, and bus controllers.

Each component therefore has associated constraints such as the particular communication protocol and transport layer it can utilize to communicate with the system. This approach of component engineering necessarily increases the platform's complexity based on the multiple different ways communication occurs, the electrical and physical constraints and resources dedicated to each mode of communication, and the “bridging” interfaces to enable bridged components to “speak” different languages yet be communicatively coupled to a common system.

In addition, some modes of communication such as legacy bus technologies have contention constraints whereby concurrent communications sent on a common pipe or bus are subject to collisions. These collisions are common in bus-based technologies which function by allowing multiple components speak on the same “channel” at the same time. This can lead to numerous issues and additional complex and expensive technologies to be present to detect such collisions and ensure retransmissions are successful. However, such technologies are particularly susceptible to attacks such as spoofing which allows malicious actors to impersonate authorized components to attack or otherwise interrupt communication buses and/or the overall system those busses support.

Therefore, and as discussed above, a VNI consistent with the present disclosure can facilitate communications between virtualized or physical endpoints or components. The VNI can convert traditionally contentious communications signals (e.g., Controller Area Network (CAN bus), RS232, RS485) into encrypted, point-to-point instances. The endpoints can be communicatively coupled via I/O pins (see I/O 350 of FIG. 3) to the VNI in a flexible manner. This allows for communication to occur between components (physical-to-physical), between components and virtualized processing resources (e.g., implemented within a RHD as discussed above), and between virtual components only (e.g., virtual-to-virtual).

The VNI may be capable of communication occurring over wired, wireless, and optical connections, and combinations thereof. In the context of connections such as signals received over optical fiber or copper, the VNI can receive such signals through an Ethernet controller. In the context of wireless connections, the VNI can receive signals via an antenna collecting RF signals.

Accordingly, a VNI consistent with the present disclosure provides numerous advantages over existing communication systems including bus-based communication systems. The VNI can convert normally bus-based communications into encrypted, point-to-point communications between authorized endpoints.

The point-to-point messaging of the VNI is performed transparently, meaning none of the endpoints are necessarily aware of this activity and thus effectively incur no penalty to performance nor require reengineering or alterations. The point-to-point messaging of the VNI utilizes the agnostic message format as discussed above.

Each point-to-point link is therefore encrypted end-to-end. This advantageously avoids attacks such as man-in-the-middle, spoofing, or other tampering with communications between endpoints. The VNI can also be informed of authorized endpoints from other systems (such as a controller or other management devices/systems/components). This model allows the VNI to ensure that components can only generate messages to, and/or receive messages from, other components that are authorized by the platform. Any compromised components are thus precluded from going ‘rogue’ within the system and attempts by such a compromised component can be immediately detected by the platform and prevented from causing harm to the system.

Thus, a system implementing a VNI consistent with the present disclosure can identify components which may have been compromised and can optionally execute one or more actions such as sending an alert and/or isolating a threat from the signal plane of the VNI, for example. In some embodiments, a system implementing a VNI consistent with the present disclosure may instantiate a new VNI to replace a compromised VNI when detected and may disable or destroy the compromised VNI.

A system implementing a VNI does not necessarily require that all endpoints in the platform understand the AST format (e.g., the agnostic message format) described above. As such, a VNI can variably select a communications format based upon whether the destination is AST-aware or not, as the case may be. In cases where the communications destination is not AST-aware, an alternate communications protocol can be selected. Similarly, the VNI is aware of these alternate communications protocol formats and is capable of receiving responses from the non-AST-aware controllers.

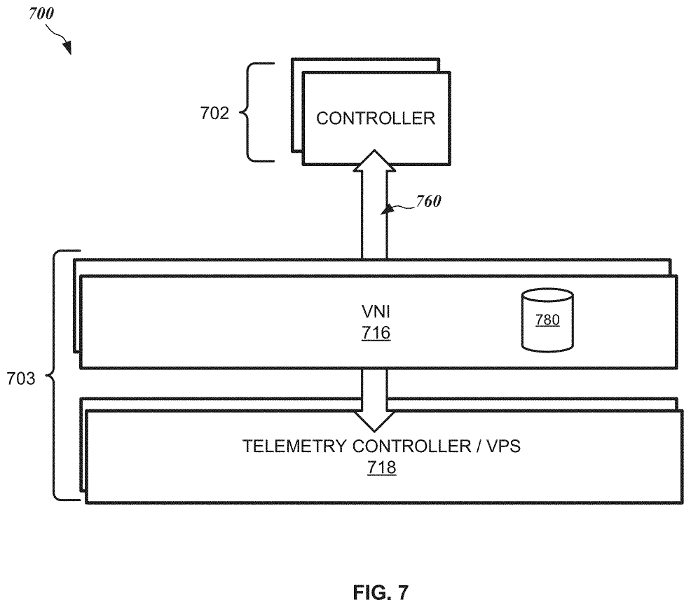

FIG. 7 shows one example 700 of a VNI 716 consistent with the present disclosure. The VNI 716 can be implemented as the VNI 116/216 (See FIGS. 1 and 3), the features and description of which is equally applicable to the VNI 716.

As shown, the example 700 includes one or more controllers 702 of which at least one controller can process messages from a component/endpoint. One such example controller includes an engine controller. The one or more controllers 702 are implemented at least in part by RHDs. Controllers implemented within RHD may be referred to as RHD-instantiated processing units.

As further shown in FIG. 7, a hardware interconnect layer 703 includes at least one VNI 716 and at least one telemetry controller 718. The at least one telemetry controller 718 may be provided by a VPS consistent with the present disclosure.

The VNI 716 includes an interface database 780. The interface database 780 includes at least a whitelist table. The whitelist table can be used to identify those controllers and/or endpoints that are allowed to communicate on the signal plane 760 via the VNI. Entries may be added or removed dynamically to the whitelist table during operation.

The interface database 780 can further include a key store for encryption of messages transmitted via the signal plane 760.

The interface database 780 includes a controller profile table that can dynamically associate the one or more controllers 702 with a target controller type. For example, each entry in the controller profile table can identify one or more controllers based on an identifier of an RHD (or the ID of an RHD-instantiated resource such as a VM instance). This identifier is a unique identifier for the particular processing instance implemented within an RHD that includes the logic for performing ‘native’ processing of a given component. For instance, the identifier may be associated with a vSoC that is instantiated with the microcode of a ‘native’ ECU. Accordingly, the interface database 780 can define a profile/representation of a virtual controller, with the virtual controller's process logic being instantiated by one or more of the RHD-instantiated processing units such as vSoCs.

During operation, a virtual controller defined within the controller profile table can be modified dynamically to add or remove target RHD-instantiated processing units. Thus, a VNI may then route messages, and messages comporting with the agnostic message format, to/from an appropriate RHD-instantiated processing unit based on performing a lookup on the controller profile table. Thus, a virtual processor may be implemented by a plurality of RHD-instantiated processing units that can be used for parallel processing of messages, or for redundancy. In the context of parallel processing, this approach allows for two or more RHD-instantiated processing units to receive identical messages from associated components. This allows multiple RHD-instantiated processing units to maintain an update-to-date state. The VNI 716 can then ignore duplicate messages output by the RHD-instantiated processing units. However, should an RHD-instantiated processing unit experience a failure or otherwise become inoperable, the remaining RHD-instantiated processing units may then continue to operate without the failing or inoperable RHD-instantiated processing unit interrupting operation of the system. Thus, a VNI consistent with the present disclosure can achieve “hot” standby instances of controllers that would traditionally be impossible to provide hot standby functionality due to the 1:1 dedicated nature of components and controllers.

A VNI consistent with the present disclosure can thus provide agnostic conversion and translation of virtually any signal capable of being represented in a digital form. Moreover, the VNI can provide encrypted, point-to-point communications for data transmissions that are normally limited to insecure communication modes. The whitelist features described above allow the VNI to further provide a level of validation and security for communication between virtual and physical components that cannot be achieved by existing communication approaches such as communication busses. The VNI can operate as, in a general sense, a network router that is able to route messages to RHD-instantiated processing units to provide a secure, fault-tolerant processing fabric that can perform the native processing of a traditional equivalent controller without necessarily requiring changes to the supporting components of the various associated subsystems.

A VNI consistent with the present disclosure can also support relatively higher data transmission rates than legacy signal/protocol pairings, such as CAN bus multiplexed over copper wires, which are capped at relatively slow data rates due to the interference and contention-based access by a plurality of communicators. Continuing with the CAN bus example, the maximum supported standards-compliant data rate is 5 Mbit/s but is only possible when the CAN bus is converted to a short point-to-point link. This necessarily removes the contention but also utility of the media for more than two devices (or endpoints) thereby increasing the wiring complexity of a platform. In contrast, a VNI consistent with the present disclosure can achieve speeds in excess of 40 Gbit/s while supporting hundreds (or thousands) of endpoints through, for example, implementation of the IEEE 802.3bm-2015 standard. This results in approximately 8000 times the throughput over the maximum theoretical throughput of CAN bus-based systems. Since VNIs consistent with the present disclosure can transparently tunnel AST-digitized messages, it is possible to complete the AST-VNI processing activities and data transfers to one or more appropriate controller(s) in a fraction of the time required in conventional deployments. This in turn allows for other features such as error detection and message retransmission that are otherwise impractical (or impossible) in the native implementation. While CAN bus is discussed herein these concepts apply to other protocols handled by the AST-VNI process.

Due to the complexities of extended enterprise environments, such as cloud service providers and satellite constellations, a VNI consistent with the present disclosure further enables secure communications to external platforms that have a VNI-aware processing system or hardware. For example, a VNI can be configured to deliver the message of a critical system to a local RHD-based vSoC instance and duplicate the message for delivery to a possibly remote endpoint such as an auditing server in a cloud enterprise or a ground base station authoritative for a satellite constellation. Moreover, a VNI can be configured to deliver an AST-digitized message directly to a remote endpoint instead of any local controller. These options are useful for various scenarios such as enabling third-party verification of activities within the platform, reducing the chances of an intrusion being able to generate arbitrary messages within the environment, or enabling blockchain validation through VNI-signed messaging.

A VNI consistent with the present disclosure can detect unauthorized communication attempts by leveraging whitelists, Mandatory Access Controls (MACs), symmetric keying, asymmetric (e.g., public key infrastructure (PKI)) cryptography, and/or similar technologies. For instance, a VNI can be hard coded with symmetric keys for the various controllers operating in the environment. When a message is destinated to one of these controllers, the VNI encrypts it using the appropriate shared secret key. Assuming a proper, secure algorithm was selected then only the controller can decrypt the message. With respect to leveraging MACs, a platform utilizing VNIs and RHDs can assign authorization (e.g., clearances) to the VNIs that restrict (via security labels) which controllers can receive messages from which VNIs. Similar verification and validation schemes are supported by the platform. These schemes enable VNIs and controllers to perform bi-directional attestation that all communications are from legitimate partners.

A VNI consistent with the present disclosure can detect unauthorized communication attempts by, for example, enforcing mandatory access control between each node. Additionally, the virtual hardware used to generate packets in a VNI may also be used for transmission security purposes. Cryptographic protection mechanics, such as end-to-end encryption can also be used to ensure MAC enforcement.

Side channel attacks take advantage of the patterns of information which can be observed external to a given target such as the amount of power a processor utilizes when executing certain routines. Side channel attacks have become a common methodology for extracting sensitive information without requiring destruction of, or direct access to, a target. Such side channel attacks can also be used to cause system interruption through fault injection whereby a malicious actor can change the behavior of a target device by active manipulation of the side channel.

One approach to preventing side-channel attacks includes masking and/or hiding countermeasures. These preventative measures are generally hand-tuned through manual processes, and such measures can be strengthened through synthesis by tools such as Electronic Design Automation (EDA) which can convert such measures to secure logic (e.g., dual-rail logic) that has these countermeasures. In operation, such countermeasures may then increase the non-determinism of signal timing through, for example, the introduction of artificial clock jitter. For components such as cryptographic units, this artificial jitter can introduce randomness to thwart side-channel attacks that would otherwise be able to count on the clocks of the cryptographic units operating with predictable timing signatures.

A secure logic fabric, such as the secure logic fabric 110 of FIG. 1, can provide a reconfigurable fabric/layer for reprogrammable devices such as FPGAs to reduce the potential for successful side-channel attacks. Note, the secure logic fabric 110 can be utilized in combination with a VPS and VNI consistent with the present disclosure to provide robust security and side-channel protection. However, the secure logic fabric is not limited in this regard and may be implemented in virtually any application (with or without VPS/VNI components) which seeks to increase the protection against side-channel attacks in RHDs.

The secure logic fabric 110 may also be referred to herein as a Secure Virtual Fabric (SVF). SVF comprises a plurality of virtual fabric elements for FPGAs which are designed to increase FPGAs resistance to side-channel attacks (e.g., fault-injection, side-channel leakage analysis, power supply monitoring, electromagnetic emissions monitoring, etc.). The SVF can be used in standalone designs (i.e., Secure Intermediate Fabric (SIF), high-performance computing applications (i.e., Secure Scalable Fabric (SSF), and multi-tenant cloud/virtualized environments (i.e., Secure Multi-tenant Fabric (SMF), Secure Elastic Fabric (SEF)), as shown in Table 1.

TABLE 1

| Design Type | Multi-Tenant | Scale-out |
|---|---|---|
| Secure Intermediate Fabric | No | No |
| (SIF) | | |
| Secure Scalable Fabric (SSF) | No | Yes |
| Secure Multi-tenant Fabric | Yes | No |
| (SMF) | | |
| Secure Elastic Fabric (SEF) | Yes | Yes |

In Table 1, multi-tenant refers to the ability for the fabric to support concurrent execution of reconfigurable hardware instances (e.g., vSoCs) from a plurality of users or systems that lack explicit trust of each other. For instance, NIST special publication 800-53 specifies multi-level security as the “concept of processing information with different classifications and categories that simultaneously permits access by users with different security clearances and denies access to users who lack authorization.” Thus, an SVF supporting multi-tenant configurations meets the associated NIST requirements for isolation and enables multi-level security.

In Table 1, scale-out refers to the ability for an SVF to support a plurality of RHDs within a single virtual reconfigurable hardware platform. This can establish whether the model supports large numbers of (possibly heterogeneous) deployments of vSoCs.

With respect to the design types from Table 1, SIF targets deployments where security and performance are an important aim. These SVF deployments can support one or two relatively small vSoC instances in a single RHD that share a degree of bi-directional trust. An SSF is generally tailored for environments that require security and scalability. These SVF deployments may support from one to several relatively large vSoC instances functioning across several RHDs where these vSoCs share a degree of bi-directional trust. An SMF generally focuses on cloud-based operations where multi-level security is required for operation and performance is optimized for latency. Such an SVF supports several relatively small vSoC instances that explicitly distrust each other and require isolation. Lastly, an SEF can be deployed in cloud-like environments where multi-level security is required, and scalability is important in order to support activities such as massively paralleled processing. These SVFs can accommodate several large vSoC instances that span across RHDs. Similar to SMF, the SEF instantiations explicitly distrust each other and require isolation.

An SVF consistent with the present disclosure achieves this protection against side-channel attacks via virtual fabric elements, as opposed to existing secure logic or hand-tuning of a design. In one example implementation, the virtual fabric elements may be provided via an array of coarsely grained programmable elements (PEs), control boxes (CBs), and switch boxes (SBs). These virtual fabric elements are relatively simple as compared to the traditional lookup tables (LUTs) that are used in existing FPGA fabrics.

A PE comprises a programmable signal manipulation element. A PE can be configured to implement complex logic manipulation and/or transformation functions.

A CB comprises a programmable signal connectivity element. A CB can be configured to provide signal connectivity between PEs and SBs.

An SB comprises a programmable logic switching element. A SB can be configured to switch signals between SBs.

The SVLEs can provide security through secure logic elements such as dual-rail logic and/or other types of specialized logic to increase its resiliency and resistance to side-channel leakages and failures. Thus, designs implemented with an SVF consistent with the present disclosure inherit this security of the SVLEs. This is because at a low-level the design can be implemented using the specialized logic, which is also portable as the SVLE is a virtual abstraction of the fabric that can be implemented across a wide variety of RHDs. This allows for the execution of SLVE-based designs in a fashion similar to how byte code software systems work. The SVLE can be described as a type of byte code that executes inside a virtual RHD that is implemented using native RHD logic elements.

A design can be synthesized to use native RHD programmable elements in a traditional workflow. Consistent with the present disclosure, the native RHD programmable elements can be used to implement SVLE(s). This can be thought of as implementing an emulator that can execute SVF designs that were compiled to work for a native RHD such as Xilinx FPGA programmable elements. Designs implemented in a register transfer level language (RTL) can be synthesized into a SVLE representation instead of the native logic. This process of converting the logic into a SVLE representation results in an intermediate logic (IL) form where special security considerations can be addressed, and advanced security principles can be applied that leverage the underlying secure logic.

A plurality of SVLEs may be defined via a tool such as SymbiFlow. The plurality of defined SVLEs can then collectively define an SVF. The plurality of defined SVLEs may then be used to generate a hyper-bitstream that can be implemented via an FPGA. In one example, a hyper-bitstream consistent with the present disclosure can take either of two forms. First, a hyper-bitstream can be a native bitstream that programs the FPGA with a static design. It is in effect a hardcoded SVF and well suited for scenarios that are not multi-tenant or do not require scale out. This is analogous to recompiling a ROM in an emulator so that it runs as native code. Alternatively, in this example, a hyper-bitstream can be a bitstream that is used by a multi-tenant or scale-out SVF instance that was pre-programmed into the FPGA. This is conceptually similar to the process of loading a ROM into an emulator. In this context, the emulator is the SVF, and the ROM is the SVLE design.

This generated hyper-bitstream may then be instantiated on any RHD, e.g., an FPGA, that is supported by SVF. To achieve these SVF deployments, the framework for SVF and associated SVLEs are ported to the RHD selected for deployment. For example, for a particular RHD to support SVF a procedure can be completed that instantiates SVF logic within that RHD. Once achieved, the RHD can natively support SVLE designs. Accordingly, the generated hyper-bitstream can be deployed on a wide range of RHDs without necessarily being constrained to a specific device type (e.g., Vitrex, Stratix, and so on) or vendor (e.g., Intel, Lattice, Xilinx, and so on).

An SVF consistent with the present disclosure also provides scale-out capabilities. This is a result of the virtual fabric nature of the SVF giving designers the perception that their design is executed/running on a single RHD that also has virtually unlimited resources. An SVF consistent with the present disclosure is particularly well suited to cloud-based applications where compute resources can be virtualized and scaled as needed (e.g., to increase RAM, the number of processors, and so on). This can be achieved through scale-out of massively parallel designs and/or by using the native SVF bitstream (see compiling to a ROM example above). Performance degradation can be avoided or reduced in massively parallel by being able to process large amounts of data currently/simultaneously. The dynamic reconstruction method can achieve relatively high performance by executing an SVF design as though it were a native design.

An SVF consistent with the present disclosure also allows for multi-tenant support, which is a feature often required by cloud-based services and systems. Thus, a single compute resource, e.g., a single physical FPGA, could be shared by multiple different tenants while providing isolation and protection from malicious actors that may have logic instantiated on the same RHD.

Additional features of an SFV consistent with the present disclosure further provide additional advantages that may include the following. First, an SIF may be optimized for standalone designs, as it lacks the overhead from the multi-tenant and scale-out logic. This is because the SIF does not necessarily require the execution of a fully virtualized RHD inside the physical RHD. In addition, this reduces latency. This is achieved by ensuring all designs are as close to the native logic as possible.

Next, an SSF may be optimized for scale-out and lacks the multi-tenant overhead, making it well suited for high-performance computing. Through implicit (and/or explicit) trust of the other co-resident operating environments, the SVF overhead can be significantly reduced. Next, an SMF may be ideal for scenarios where an FPGA cluster is not required, but multiple tenants may want to share the hardware. Finally, an SEF may be optimized for traditional cloud environments and has support for multiple tenants and scale-out.

A list of other non-limiting embodiments that can utilize aspects of the present disclosure include mobile devices, network devices, ‘smart’ devices and appliances, supervisory control and data acquisition (SCADA) systems, nuclear command and control platforms, missile systems, airplane and air traffic control systems, traffic and freight systems, and others. Note, not all components as shown in the figures and described above are necessary in all implementations that seek to leverage the VPS architecture 100. For instance, a mobile platform may decide to forego RHD 120-1 in favor of an application specific integrated circuit (ASIC) or similar non-reconfigurable design. These ASICs can still be configured and manufactured in a manner that implements, for example, the VM 104-1, controller 106-1, and vSoC 108-1. This particular design can reduce power, space, and cooling requirements, which is desirable in relatively small products/devices such as smartphones and portable devices.

According to one aspect of the disclosure there is thus provided a system for virtualizing communication channels between one or more hardware components and a controller, the system including: a first controller implemented in a reconfigurable hardware device; and a virtual platform stratus having a plurality of input/output (I/O) ports for electrically coupling with the one or more hardware components and receiving one or more electrical signals therefrom, and where the VPS is configured to generate one or more data frames from the one or more electrical signals; and where the virtual platform stratus is configured to send the data frames to the first controller and/or provide electrical signaling to the one or the one or more hardware components based on data frames received from the first controller.

According to another aspect of the disclosure there is thus provided a system for virtualizing communication channels between one or more hardware components and a controller, the system including: a first controller implemented in a reconfigurable hardware device; and a virtual platform stratus having a plurality of input/output ports for electrically coupling with the one or more hardware components and receiving one or more electrical signals therefrom, and where the virtual platform stratus is configured to generate data frames from the one or more electrical signals, where the virtual platform stratus is configured to send the data frames to the first controller and/or provide electrical signaling to the one or the one or more hardware components based on data frames received from the first controller; and a secure virtual fabric, where the secure virtual fabric comprises one or more virtual fabric elements to prevent side-channel attacks.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Embodiments of the methods described herein may be implemented using a controller, processor and/or other programmable device. To that end, the methods described herein may be implemented on a tangible, non-transitory computer readable medium having instructions stored thereon that when executed by one or more processors perform the methods. Thus, for example, the memory 1036 may store instructions (in, for example, firmware or software) to perform the operations described herein. The storage medium, e.g. the memory 1036, may include any type of tangible medium, for example, any type of disk optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A system for virtualizing communication channels between one or more hardware components and a controller, the system comprising:
a first controller implemented in a reconfigurable hardware device (RHD); and
a virtual platform stratus (VPS) having a plurality of input/output (I/O) ports for electrically coupling with the one or more hardware components and receiving one or more electrical signals therefrom, and wherein the VPS is configured to generate one or more data frames from the one or more electrical signals;
wherein the VPS is configured to send the data frames to the first controller and/or provide electrical signaling to the one or the one or more hardware components based on data frames received from the first controller.

2. The system of claim 1, wherein the first controller is implemented as a virtual System-on-Chip (vSoC) instance.

3. The system of claim 1, wherein the system further comprises a telemetry database that includes a table for mapping each of the plurality of I/O ports with an identifier of a hardware component type.

4. The system of claim 1, wherein the one or more hardware components are configured to output one or more signals, and wherein the VPS is configured to convert an analog signal to a digital signal and generate the data frames from the digital signal.

5. The system of claim 4, wherein any of the one or more hardware components is configured to convert the analog signal to the digital signal and convert the digital signal into any supported standard.

6. The system of claim 1, further comprising a second controller, the second controller being configured as a same type as the first controller for redundancy.

7. The system of claim 6, wherein the VPS is configured to send the one or more data frames to the second controller based on a fault occurring with the first controller.

8. The system of claim 1, further comprising a virtual network interface (VNI) using a point-to-point messaging between authorized endpoints, wherein:
the VNI ensures that the system can only process messages to and from other components that are authorized by the system, and
the VNI converts arbitrary communications from a plurality of protocols into the point-to-point messaging.

9. The system of claim 8, wherein the VNI implements bus-based technologies using the point-to-point messaging.

10. The system of claim 8 wherein the point-to-point messaging is encrypted.

11. A system for virtualizing communication channels between one or more hardware components and a controller, the system comprising:
a first controller implemented in a reconfigurable hardware device (RHD);
a virtual platform stratus (VPS) having a plurality of input/output (I/O) ports for electrically coupling with the one or more hardware components and receiving one or more electrical signals therefrom, and wherein the VPS is configured to generate data frames from the one or more electrical signals, wherein the VPS is configured to send the data frames to the first controller and/or provide electrical signaling to the one or the one or more hardware components based on data frames received from the first controller; and
a secure virtual fabric (SVF), wherein the SVF comprises one or more virtual fabric elements to prevent side-channel attacks.

12. The system of claim 11, wherein the side-channel attacks are selected from the group consisting of fault-injection, side-channel leakage analysis, power supply monitoring, and electromagnetic emissions monitoring.

13. The system of claim 11, wherein:
the one or more virtual fabric elements are provided by an array of coarsely grained programmable elements, and
the array of coarsely grained programmable elements includes a programmable signal connectivity element that is configured to implement complex logic manipulation and transformation functions.

14. The system of claim 11, wherein the SVF implements one or more secure logic elements to prevent the side-channel attacks.

15. The system of claim 14, wherein the one or more secure logic elements use dual-rail logic.

16. The system of claim 11, wherein the first controller is implemented as a virtual System-on-Chip (vSoC) instance.

17. The system of claim 11, wherein the system further comprises a telemetry database that includes a table for mapping each of the plurality of I/O ports with an identifier of a hardware component type.

18. The system of claim 11, wherein the one or more hardware components are configured to output one or more signals, and wherein the VPS is configured to convert an analog signal to a digital signal and generate the data frames from the digital signal.

19. The system of claim 18, wherein any of the one or more hardware components is configured to convert the analog signal to the digital signal and convert the digital signal into any supported standard.

20. The system of claim 11, further comprising a second controller, the second controller being configured as a same type as the first controller for redundancy.
